(19) United States
(12) Patent Application Publication
(10) Pub. No.: US 2026/0039053 A1
(43) Pub. Date: Feb. 5, 2026

(54) ELECTRICAL CONNECTOR WITH TERMINAL CARRIERS

(71) Applicant: Lear Corporation, Southfield, MI (US)

(72) Inventors: Jordi Angel Serrano, Remscheid (DE); Xavier Farré Vives, Valls (Tarragona) (ES); Verena Kassner, Remscheid (DE); Uemit Celiker, Remscheid (DE)

(73) Assignee: Lear Corporation, Southfield, MI (US)

(21) Appl. No.: 19/288,621

(22) Filed: Aug. 1, 2025

(30) Foreign Application Priority Data
Aug. 4, 2024 (DE) 102024122405.3

(51) Int. Cl. H01R 13/514; H01R 13/436

(52) U.S. Cl. CPC H01R 13/514; H01R 13/436

(57) ABSTRACT

An electrical connector includes a frame that defines a module cavity. The module cavity includes an insertion opening on an insertion end of the frame. The electrical connector includes a first module that defines a first terminal cavity adapted to accommodate a first electrical terminal. The electrical connector also includes a second module that defines a second terminal cavity adapted to accommodate a second electrical terminal. The first module is movable relative to the frame through the insertion opening and a first lock retains the first module in a first module position. The second module is movable relative to the frame through the insertion opening and a second lock retains the second module in a second module position.

### FIELD

This disclosure relates to an electrical connector. More specifically, this disclosure relates to an improved electrical connector with terminal carriers.

### BACKGROUND

Electrical connectors typically hold multiple electrical terminals and allow the multiple electrical terminals to be mated with multiple corresponding terminals. A carrier type electrical connector includes one or more terminal carriers that can be loaded with electrical terminals. The individual carriers can then be loaded into single frame to create a single electrical connector assembly. It is desirable to provide an improved carrier type electrical connector.

### SUMMARY

Various example electrical connectors are described.

An example electrical connector includes a frame. The frame comprises an insertion end. The frame defines a module cavity. The module cavity includes an insertion opening on the insertion end. The electrical connector includes a first module. The first module has a first module body. The first module body defines a first terminal cavity that is adapted to accommodate a first electrical terminal. The electrical connector includes a second module. The second module has a second module body. The second module body defines a second terminal cavity that is adapted to accommodate a second electrical terminal. The first module is movable relative to the frame through the insertion opening to a first module position. A first lock retains the first module in the first module position relative to the frame. The second module is movable relative to the frame through the insertion opening to a second module position. A second lock retains the second module in the second module position relative to the frame. The first module body in the first module position is farther from the insertion opening than the second module body in the second module position.

Another example electrical connector includes a frame. The frame comprises an insertion end. The frame defines a module cavity. The module cavity includes an insertion opening on the insertion end. The electrical connector includes a first module. The first module has a first module body. The first module body defines a first terminal cavity that is adapted to accommodate a first electrical terminal. The electrical connector includes a second module. The second module has a second module body. The second module body defines a second terminal cavity that is adapted to accommodate a second electrical terminal. The first module is movable relative to the frame through the insertion opening to a first module position. A first lock retains the first module in the first module position relative to the frame. The second module is movable relative to the frame through the insertion opening to a second module position. A second lock retains the second module in the second module position relative to the frame.

Another example electrical connector includes a frame. The frame defines a module cavity. A first module is retained in the module cavity in a first module position. The first module comprising a first module body. The first module body defining a first A terminal cavity adapted to accommodate a first A electrical terminal. The first module body defining a first B terminal cavity adapted to accommodate a first B electrical terminal. The first module including a first A module arm extending from the first module body. The first module including a first B module arm extending from the first module body. A second module is retained in the module cavity in a second module position. The second module comprising a second module body. The second module body defining a second A terminal cavity adapted to accommodate a second A electrical terminal. The second module body defining a second B terminal cavity adapted to accommodate a second B electrical terminal. The second module including a second A module arm extending from the second module body. The second module including a second B module arm extending from the second module body. The first A module arm is a terminal position assurance for the second A terminal cavity. The first B module arm is a terminal position assurance for the second B terminal cavity. The second A module arm is a terminal position assurance for the first A terminal cavity. And the second B module arm is a terminal position assurance for the first B terminal cavity.

Additional understanding of these examples will become apparent to those skilled in the art from the following detailed description, when read in light of the accompanying drawings.

### BRIEF DESCRIPTION OF THE DRAWINGS

FIG. 1 is a front perspective view of an example electrical connector.

FIG. 2 is a cross-sectional view of the electrical connector illustrated in FIG. 1 taken along the line 2-2.

FIG. 3 is an exploded view of the electrical connector illustrated in FIG. 1, illustrating a frame separated from a first module and a second module.

FIG. 4 is an end view of the first module illustrated in FIG. 3.

FIG. 5 is an end view of the second module illustrated in FIG. 3.

FIG. 6 is a cross-sectional view similar to FIG. 2, showing the first module attached to the frame.

FIG. 7 is a cross-sectional view of the electrical connector illustrated in FIG. 1, with the second module has been omitted for clarity, taken along the line 7-7 in FIG. 6.

FIG. 8 is a cross-sectional view of the electrical connector illustrated in FIG. 1 taken along the line 8-8 in FIG. 2.

FIG. 9 is a cross-sectional view of the electrical connector illustrated in FIG. 1 taken along the line 9-9 in FIG. 8.

FIG. 10 is a cross-sectional view of the electrical connector illustrated in FIG. 1 taken along the line 10-10 in FIG. 8.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

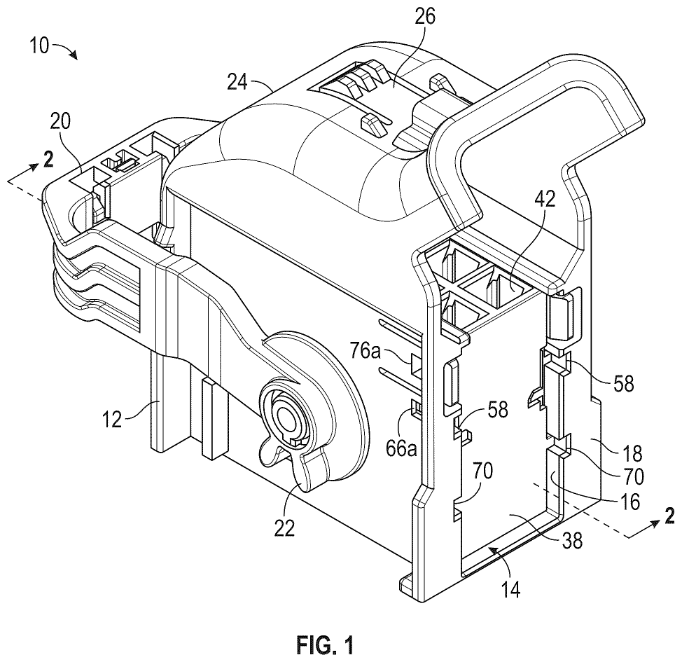

Referring now to the drawings there is illustrated in FIG. 1 a front perspective view of an electrical connector, indicated generally at 10. The electrical connector 10 includes a frame 12 that defines a module cavity, indicated generally at 14. The module cavity 14 includes an insertion opening 16 located at an insertion end 18 of the frame 12.

The electrical connector 10 includes a lever 20 that is attached to the frame 12 for relative movement between a pre-mate position and a mated position. FIG. 1 illustrates the lever 20 in the pre-mate position. The lever 20 includes teeth 22 to assist in mating the electrical connector 10 with a corresponding connector (not shown), as is known in the art. The electrical connector 10 includes a wire guide 24 and in the illustrated embodiment the wire guide 24 is part of the frame 12. A latch 26 on the frame 12 engages the lever 20 when the lever 20 is in the mated position in order to retain the lever 20 in the mated position relative to the frame 12.

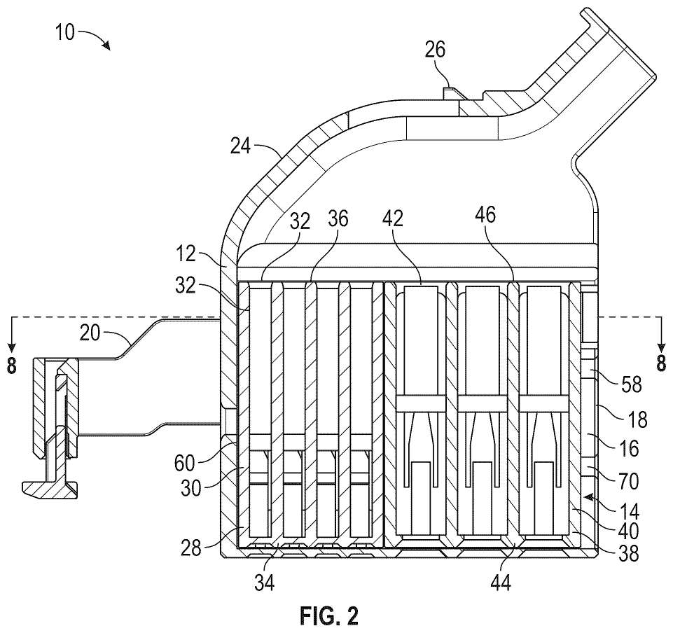

FIG. 2 is a cross-sectional view taken along the line 2-2 in FIG. 1. The electrical connector 10 includes a first module 28 that is located in the module cavity 14. The first module 28 includes a first module body 30 that defines a first terminal cavity 32. The first terminal cavity 32 is adapted to accommodate a first electrical terminal (not shown). The first terminal cavity 32 extends from a first mating end 34 of the first module body 30 to a first insertion end 36 of the first module body 30.

The electrical connector 10 also includes a second module 38 that is located in the module cavity 14. The second module 38 includes a second module body 40 that defines a second terminal cavity 42. The second terminal cavity 42 is adapted to accommodate a second electrical terminal (not shown). The second terminal cavity 42 extends from a second mating end 44 of the second module body 40 to a second insertion end 46 of the second module body 40.

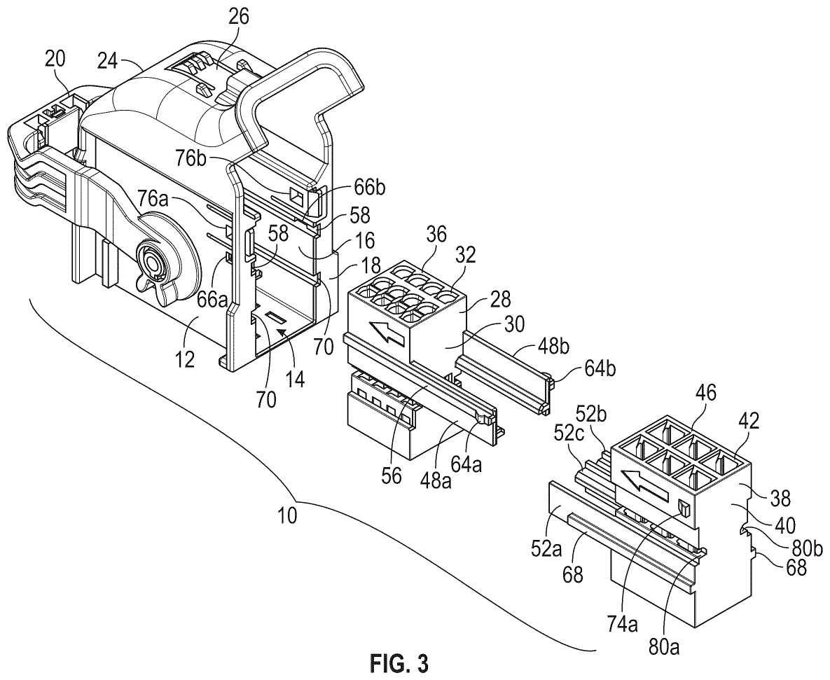

Referring to FIG. 3, an exploded front perspective view of the electrical connector 10 is shown. As illustrated in FIG. 3, the first module 28 and the second module 38 are separate from the frame 12. As shown in FIG. 3, the illustrated first module 28 includes multiple first terminal cavities 32. The illustrated first module 28 includes three rows of first terminal cavities 32, each row including four first terminal cavities 32. However, the first module 28 may include any desired number of first terminal cavities 32. Each of the illustrated first terminal cavities 32 is the same size, but the individual first terminal cavities 32 may be any desired size. Additionally, the illustrated second module 38 includes multiple second terminal cavities 42. The illustrated second module 38 includes two rows of second terminal cavities 42, each row including three second terminal cavities 42. However, the second module 38 may include any desired number of second terminal cavities 42. Each of the illustrated second terminal cavities 42 is the same size, but the individual second terminal cavities 42 may be any desired size. In the illustrated embodiment, the second terminal cavities 42 are larger than the first terminal cavities 32, but the terminal cavities may have any desired relative sizes.

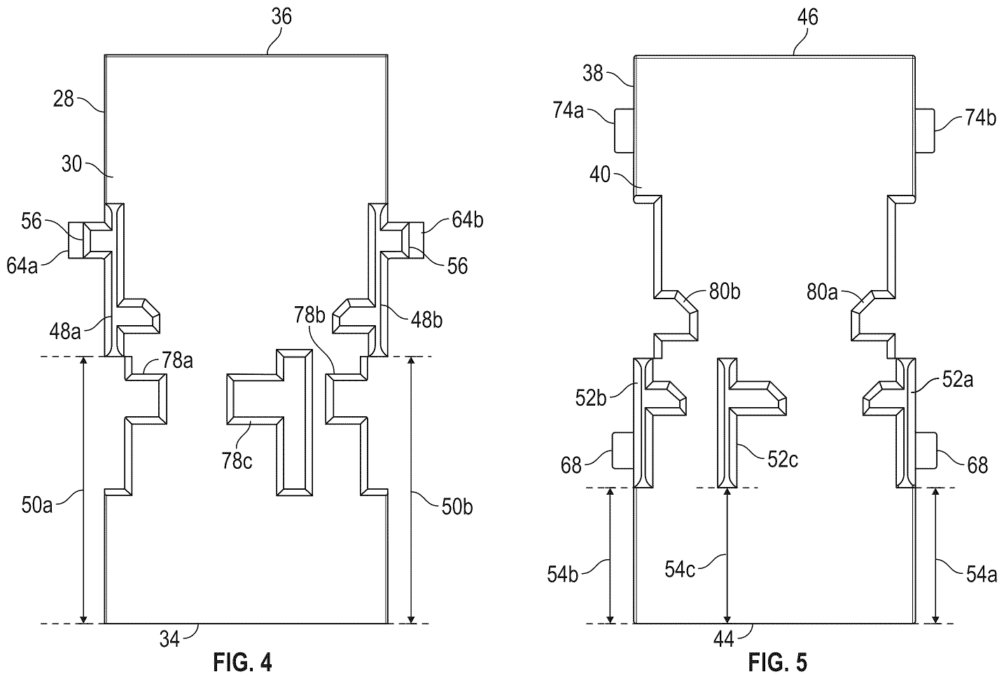

The first module 28 includes a first A module arm 48a and a first B module arm 48b that extend from the first module body 30. The illustrated first module 28 includes two first module arms 48a and 48b but may include any desired number of first module arms. FIG. 4 is an end view of the first module 28. As shown, the first A module arm 48a is located a first A module arm distance 50a from the first mating end 34, and the first B module arm 48b is located a first B module arm distance 50b from the first mating end 34. In the illustrated embodiment, the first A module arm distance 50a is the same as the first B module arm distance 50b. However, the first A module arm distance 50a and the first B module arm distance 50b may be different, if desired.

Similarly, the second module 38 includes a second A module arm 52a, a second B module arm 52b, and a second C module arm 52c that extend from the second module body 40. The illustrated second module 38 includes three second module arms 52a, 52b, and 52c, but may include any desired number of second module arms. FIG. 5 is an end view of the second module 38. As shown, the second A module arm 52a is located a second A module arm distance 54a from the second mating end 44, the second B module arm 52b is located a second B module arm distance 54b from the second mating end 44, and the second C module arm 52c is located a second C module arm distance 54c from the second mating end 44. In the illustrated embodiment, the second A module arm distance 54a, is the same as the second B module arm distance 54b and the second C module arm distance 54c. However, the second A module arm distance 54a, the second B module arm distance 55b, and the second C module arm distance may be different, if desired. As shown in FIGS. 4 and 5, the first A module arm distance 50a is different from the second A module arm distance 54a.

In order to assemble the electrical connector 10, the first module 28 is moved relative to the frame 12 through the insertion opening 16. The first module 28 includes a first module guide 56 that cooperates with a first frame guide 58 on the frame 12 in order to limit movement of the first module 28 relative to the frame 12. In the illustrated embodiment, the first module guide 56 is a raised projection that is located on the first module body 30 and the first A module arm 48a and the first frame guide 58 is a trench located on a side of the module cavity 14. The illustrated electrical connector includes two first module guides 56 and two first frame guides 58, which are located on opposite sides of the first module 28 and the module cavity 14, respectively.

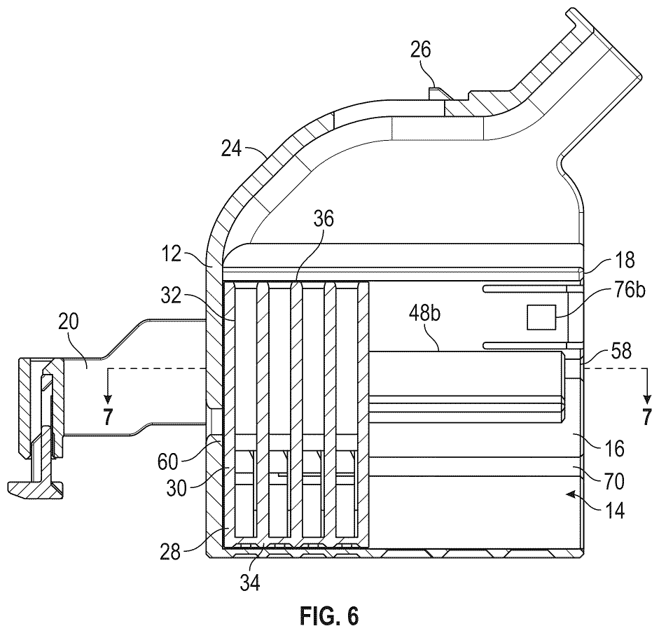

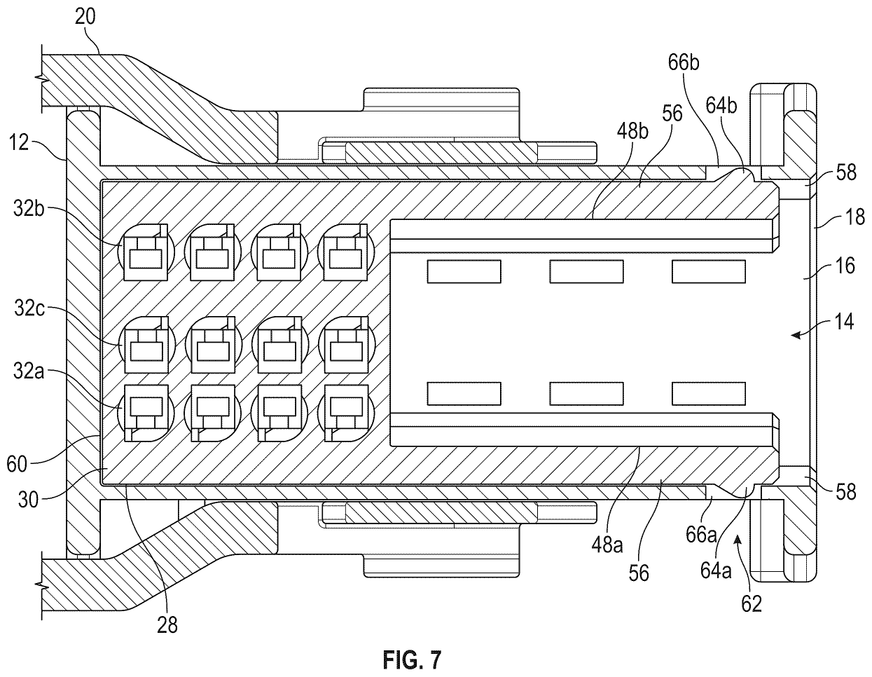

Referring to FIG. 6, the first module 28 is moved relative to the frame 12 towards a back wall 60 of the frame 12. The back wall 60 is located on the opposite side of the module cavity 14 from the insertion opening 16. The first module 28 is moved relative to the frame 12 towards a back wall 60 until the first module 28 is located in a first module position relative to the frame 12. As shown in FIG. 7, a first lock 62 retains the first module 28 in the first module position relative to the frame 12. Referring to FIG. 7, the first lock 62 includes a tab 64a on the first A module arm 48a and a notch 66a on the frame 12. However, any desired lock may be used. The illustrated first module 28 includes two tabs 64a and 64b, and the illustrated frame 12 includes two notches 66a and 66b, which are located on opposite sides of the first module 28 and the module cavity 14, respectively. When the first module 28 is in the first module position, the first module arms 48a and 48b extend from the first module body 30 towards the insertion opening 16.

The second module 38 is then moved relative to the frame 12 through the insertion opening 16. As shown in FIG. 3, the second module 38 includes a second module guide 68 that cooperates with a second frame guide 70 on the frame 12 in order to limit movement of the second module 38 relative to the frame 12. In the illustrated embodiment, the second module guide 68 is a raised projection that is located on the second module body 40 and the second A module arm 52a and the second frame guide 70 is a trench located on a side of the module cavity 14. The illustrated electrical connector includes two second module guides 68 and two second frame guides 70, which are located on opposite sides of the second module 38 and the module cavity 14, respectively.

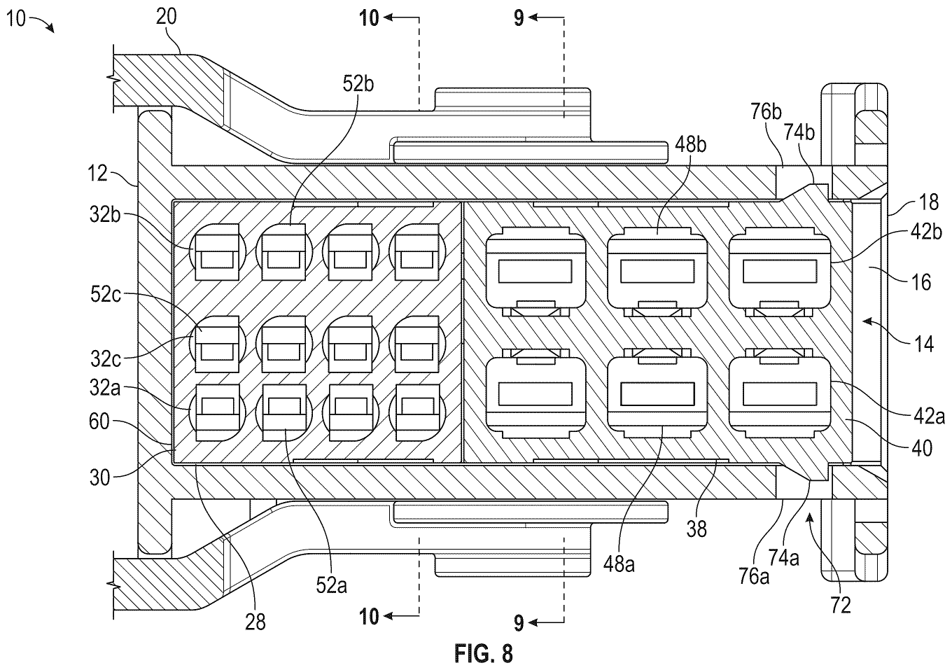

Referring to FIG. 2, the second module 38 is moved relative to the frame 12 towards the back wall 60 of the frame 12 until the second module 38 is located in a second module position relative to the frame 12. As shown in FIG. 8, a second lock 72 retains the second module 38 in the second module position relative to the frame 12. Referring to FIG. 8, the second lock 72 includes a tab 74a on the second A module arm 52a and a notch 76a on the frame 12. However, any desired lock may be used. The illustrated second module 38 includes two tabs 74a and 74b, and the illustrated frame 12 includes two notches 76a and 76b, which are located on opposite sides of the second module 38 and the module cavity 14, respectively. When the second module 38 is in the second module position, the second module arms 52a, 52b, and 52c extend from the second module body 40 away from the insertion opening 16.

As shown in FIGS. 2 and 8, when the first module 28 is in the first module position and the second module 38 is in the second module position, the first module body 30 is farther from the insertion opening 16 than the second module body 40. As shown in FIG. 2, in the illustrated embodiment the first mating end 34 is adjacent to the second mating end 44.

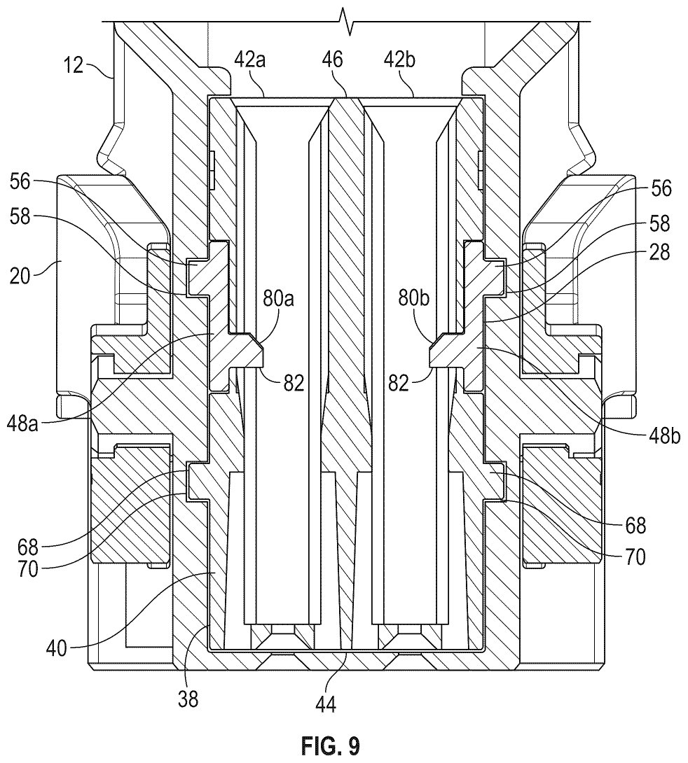

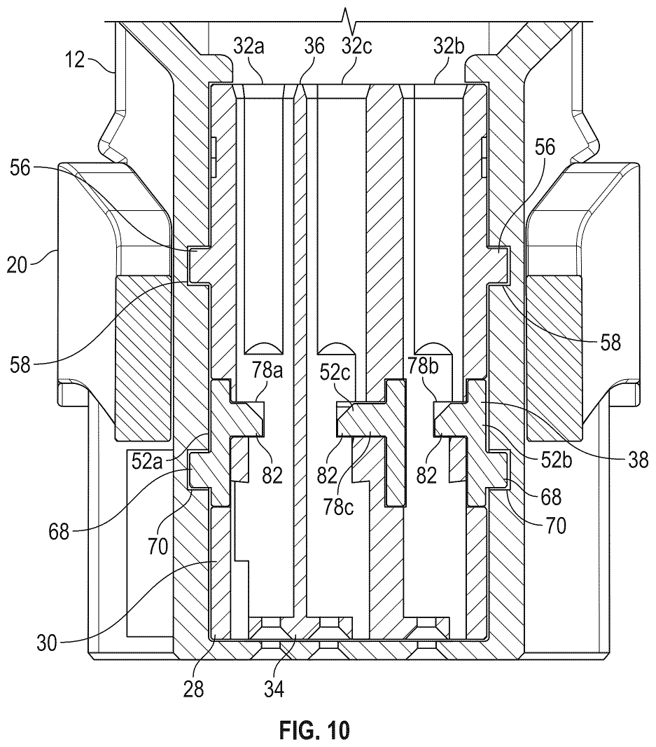

As shown in FIG. 4, the first module 28 includes a first A module opening 78a, a first B module opening 78b, and a first C module opening 78c. As shown in FIG. 5, the second module 38 includes a second A module opening 80a and a second B module opening 80b. When the first module 28 is in the first module position and the second module 38 is in the second module position, the first A module arm 48a is located in the second A module opening 80a, and the first B module arm 48b is located in the second B module opening 80b. This is shown in the cross-section illustrated in FIG. 9. Further, the second A module arm 52a is located in the first A module opening 78a, the second B module arm 52b is located in the first A module opening 78b, and the second C module arm 52c is located in the first C module opening 78c. This is shown in the cross-section illustrated in FIG. 10.

Referring to FIG. 8, as previously described the illustrated first module 28 includes three rows of first terminal cavities 32, which are identified as 32a, 32b, and 32c. Additionally, the illustrated second module 38 includes two rows of second terminal cavities 42, which are identified as 42a and 42b. The first module openings 78a, 78b, and 76c extend partially through the respective first terminal cavities 32a, 32b, and 32c. The second module arms 52a, 52b, and 52c are located at least partially in the respective first terminal cavities 32a, 32b, and 32c. The second module arms 52a, 52b, and 52c are adapted to be a terminal position assurance for the respective terminal cavities 32a, 32b, and 32c. Referring to FIG. 10, the second A module arm 52a is located at least partially in the first A terminal cavity 32a. The second A module arm 52a includes a stop surface 82 that is located in the first A terminal cavity 32a, and the second A module arm 52a is a terminal position assurance for the first A terminal cavity 32a. Similarly, the second B module arm 52b is located at least partially in the first B terminal cavity 32b. And the second B module arm 52b is a terminal position assurance for the first B terminal cavity 32b. The second C module arm 52c is located at least partially in the first C terminal cavity 32c. And the second C module arm 52c is a terminal position assurance for the first C terminal cavity 32c.

Referring to FIG. 9, the first A module arm 48a is located at least partially in the second A terminal cavity 42a. And the first A module arm 48a is a terminal position assurance for the second A terminal cavity 42a. Similarly, the first B module arm 48b is located at least partially in the second B terminal cavity 42b. And the first B module arm 48b is a terminal position assurance for the second B terminal cavity 42b.

Referring back to FIG. 4, the first A module arm 48a and the first B module arm 48b are located on opposite side of the first module body 30. However, the first module arms 48a and 48b may be located on any desired location on the first module body 30. And referring to FIG. 5, the second A module arm 52a and second B module arm 52b are located on opposite sides of the second module body 40, while the second C module arm 52c is located between the second A module arm 52a and second B module arm 52b. However, the second module arms 52a, 52b, and 52c may be located on any desired location on the second module body 40.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

1. An electrical connector comprising:
a frame comprising an insertion end, the frame defining a module cavity comprising an insertion opening on the insertion end;
a first module comprising a first module body comprising a first terminal cavity adapted to accommodate a first electrical terminal; and
a second module comprising a second module body comprising a second terminal cavity adapted to accommodate a second electrical terminal;
wherein the first module is movable relative to the frame through the insertion opening to a first module position, wherein a first lock retains the first module in the first module position relative to the frame;
wherein the second module is movable relative to the frame through the insertion opening to a second module position, wherein a second lock retains the second module in the second module position relative to the frame; and
wherein the first module body in the first module position is farther from the insertion opening than the second module body in the second module position.

2. The electrical connector of claim 1, further comprising a first module arm extending from the first module body toward the insertion opening and located at least partially in the second terminal cavity; and
further comprising a second module arm extending from the second module body away from the insertion opening and located at least partially in the first terminal cavity.

3. The electrical connector of claim 2, wherein the first module comprises a first mating end, the first module arm located a first module arm distance from the first mating end;
wherein the second module comprises a second mating end, the second module arm located a second module arm distance from the second mating end; and
wherein the first module arm distance is different from the second module arm distance.

4. The electrical connector of claim 3, wherein the first mating end is located adjacent to the second mating end.

5. The electrical connector of claim 1, further comprising a first module arm extending from the first module body towards the insertion opening, the first module arm being a terminal position assurance for the second terminal cavity; and
further comprising a second module arm extending from the second module body away from the insertion opening, the second module arm being a terminal position assurance for the first terminal cavity.

6. The electrical connector of claim 1, wherein the first terminal cavity is a first A terminal cavity adapted to accommodate a first A electrical terminal, and the second terminal cavity is a second A terminal cavity adapted to accommodate a second A electrical terminal;
wherein the first module body further comprises a first B terminal cavity adapted to accommodate a first B electrical terminal, a first A module arm extending from the first module body towards the insertion opening, and a first B module arm extending from the first module body towards the insertion opening;
wherein the second module body further comprises a second B terminal cavity adapted to accommodate a second B electrical terminal, a second A module arm extending from the second module body away from the insertion opening, and a second B module arm extending from the second module body away from the insertion opening; and
wherein the first A module arm is located at least partially in the second A terminal cavity, the first B module arm is located at least partially in the second B terminal cavity, the second A module arm is located at least partially in the first A terminal cavity, and the second B module arm is located at least partially in the first B terminal cavity.

7. The electrical connector of claim 1, wherein the first terminal cavity is a first A terminal cavity adapted to accommodate a first A electrical terminal, and the second terminal cavity is a second A terminal cavity adapted to accommodate a second A electrical terminal;
wherein the first module body further comprises a first B terminal cavity adapted to accommodate a first B electrical terminal, a first A module arm extending from the first module body towards the insertion opening, and a first B module arm extending from the first module body towards the insertion opening;
wherein the second module body further comprises a second B terminal cavity adapted to accommodate a second B electrical terminal, a second A module arm extending from the second module body away from the insertion opening, and a second B module arm extending from the second module body away from the insertion opening; and
wherein the first A module arm is a terminal position assurance for the second A terminal cavity, the first B module arm is a terminal position assurance for the second B terminal cavity, the second A module arm is a terminal position assurance for the first A terminal cavity, and the second B module arm is a terminal position assurance for the first B terminal cavity.

8. The electrical connector of claim 7, wherein the first A module arm and the first B module arm are located on opposite sides of the first module body.

9. An electrical connector comprising:
a frame comprising an insertion end, the frame defining a module cavity comprising an insertion opening on the insertion end;
a first module comprising a first module body comprising a first terminal cavity adapted to accommodate a first electrical terminal; and
a second module comprising a second module body that defines a second terminal cavity adapted to accommodate a second electrical terminal;
wherein the first module is movable relative to the frame through the insertion opening to a first module position, wherein a first lock retains the first module in the first module position relative to the frame; and
wherein the second module is movable relative to the frame through the insertion opening to a second module position, wherein a second lock retains the second module in the second module position relative to the frame.

10. The electrical connector of claim 9, further comprising a first module arm extending from the first module body towards the insertion opening and located at least partially in the second terminal cavity; and
a second module arm extending from the second module body away from the insertion opening and located at least partially in the first terminal cavity.

11. The electrical connector of claim 10, wherein the first module comprises a first mating end, the first module arm located a first module arm distance from the first mating end;
wherein the second module comprises a second mating end, the second module arm located a second module arm distance from the second mating end; and
wherein the first module arm distance is different from the second module arm distance.

12. The electrical connector of claim 11, wherein the first mating end is located adjacent to the second mating end.

13. The electrical connector of claim 9, further comprising a first module arm extending from the first module body towards the insertion opening, the first module arm being a terminal position assurance for the second terminal cavity; and
further comprising a second module arm extending from the second module body away from the insertion opening, the second module arm being a terminal position assurance for the first terminal cavity.

14. The electrical connector of claim 9, wherein the first terminal cavity is a first A terminal cavity adapted to accommodate a first A electrical terminal, and the second terminal cavity is a second A terminal cavity adapted to accommodate a second A electrical terminal;
wherein the first module body further comprises a first B terminal cavity adapted to accommodate a first B electrical terminal, a first A module arm extending from the first module body towards the insertion opening, and a first B module arm extending from the first module body towards the insertion opening;
wherein the second module body further comprises a second B terminal cavity adapted to accommodate a second B electrical terminal, a second A module arm extending from the second module body away from the insertion opening, and a second B module arm extending from the second module body away from the insertion opening; and
wherein the first A module arm is located at least partially in the second A terminal cavity, the first B module arm is located at least partially in the second B terminal cavity, the second A module arm is located at least partially in the first A terminal cavity, and the second B module arm is located at least partially in the first B terminal cavity.

15. The electrical connector of claim 9, wherein the first terminal cavity is a first A terminal cavity adapted to accommodate a first A electrical terminal, and the second terminal cavity is a second A terminal cavity adapted to accommodate a second A electrical terminal;
wherein the first module body further comprises a first B terminal cavity adapted to accommodate a first B electrical terminal, a first A module arm extending from the first module body towards the insertion opening, and a first B module arm extending from the first module body towards the insertion opening;
wherein the second module body further comprises a second B terminal cavity adapted to accommodate a second B electrical terminal, a second A module arm extending from the second module body away from the insertion opening, and a second B module arm extending from the second module body away from the insertion opening; and
wherein the first A module arm is a terminal position assurance for the second A terminal cavity, the first B module arm is a terminal position assurance for the second B terminal cavity, the second A module arm is a terminal position assurance for the first A terminal cavity, and the second B module arm is a terminal position assurance for the first B terminal cavity.

16. The electrical connector of claim 15, wherein the first A module arm and the first B module arm are located on opposite sides of the first module body.

17. An electrical connector comprising:
a frame defining a module cavity;
a first module retained in the module cavity in a first module position, the first module comprising a first module body defining a first A terminal cavity adapted to accommodate a first A electrical terminal, and a first B terminal cavity adapted to accommodate a first B electrical terminal, the first module comprising a first A module arm extending from the first module body and a first B module arm extending from the first module body; and
a second module retained in the module cavity in a second module position, the second module comprising a second module body defining a second A terminal cavity adapted to accommodate a second A electrical terminal, and a second B terminal cavity adapted to accommodate a second B electrical terminal, the second module comprising a second A module arm extending from the second module body and a second B module arm extending from the second module body;
wherein the first A module arm is a terminal position assurance for the second A terminal cavity, the first B module arm is a terminal position assurance for the second B terminal cavity, the second A module arm is a terminal position assurance for the first A terminal cavity, and the second B module arm is a terminal position assurance for the first B terminal cavity.

18. The electrical connector of claim 17, wherein the first A module arm is located at least partially in the second A terminal cavity, the first B module arm is located at least partially in the second B terminal cavity, the second A module arm is located at least partially in the first A terminal cavity, and the second B module arm is located at least partially in the first B terminal cavity.

19. The electrical connector of claim 17, wherein a first lock retains the first module in the first module position relative to the frame, and a second lock retains the second module in the second module position relative to the frame.

20. The electrical connector of claim 17, wherein the first module comprises a first mating end, the first module arm located a first module arm distance from the first mating end;
wherein the second module comprises a second mating end, the second module arm located a second module arm distance from the second mating end;
wherein the first module arm distance is different from the second module arm distance; and
wherein the first mating end is located adjacent to the second mating end.
